(19) United States
(12) Patent Application Publication
(10) Pub. No.: US 2020/0167541 A1
(43) Pub. Date: May 28, 2020

(54) FINGERPRINT-OPERATED SCANNER RING

(71) Applicant: Awatif Rabee Masoud ALLHYANI, Makkah (SA)

(72) Inventor: Awatif Rabee Masoud ALLHYANI, Makkah (SA)

(21) Appl. No.: 16/466,039

(22) PCT Filed: May 14, 2017
(86) PCT No.: PCT/SA2017/050005

§ 371 Date: Feb. 6, 2020

(30) Foreign Application Priority Data
Dec. 6, 2016 (GC) 32504

(51) Int. Cl. G06K 9/00; G06F 3/01; G06K 7/10

(52) U.S. Cl. CPC G06K 9/0004; G06K 9/00087; G06K 2007/10534; G06K 7/10891; G06F 3/014

(57) ABSTRACT

The current invention which consists of a portable easy-to-use ring (6) that can be worn on the finger. It is used to scan data or materials that is desired to be scanned, then it is stored and transferred wirelessly to any other display or storage unit. This ring consists a programmer (2), storage memory (1), fingerprint detector (3) and one lens for scanning (4). The current invention's feature is that the device can scan the selected area by finger only. This invention is designed to be only used by the authorized persons, and that is by setting the fingerprint in a fingerprint detector (3), so that the user can use the device to transfer, display, or save data.

### DETAILED DESCRIPTION

### Technical Background

This invention is related to the techniques of scanners in which the required information is scanned, transferred and converted into special extensions (e.g. PDF, JPEG, GIF) through different techniques for viewing, transferring or storing them on other devices. There are similar devices available in the markets, but they are large in size and difficult to carry everywhere, or medium in size and need a place to be stored and carried in a special bag from one place to another. There are also other devices such as, barcode readers, are used to display certain prices for particular products or to add or display products or their information in the warehouse for example. These devices transfer information directly from the barcode reader to another device or to a central information unit to collect data. One of the disadvantages of these devices is that any anonymous person can use them, which may make it difficult to know the identity of the person who entered the wrong data or information, especially if the products or information is important, private or confidential. So, there is a need to provide a portable easy-to-use device with high security feature.

### DISCLOSURE OF THE INVENTION

In light of the above, the objective of the current invention is to provide security and protection of information scanned using fingerprint. This objective is achieved by a portable easy-to-use ring which can be worn on the finger and used to wirelessly scan, store and transfer data wirelessly to any other display or storage unit. This ring (6) consists of a programmer (2), storage memory (1), fingerprint detector (3) and one lens for scanning (4) installed on the front of the ring (5).

### THE BENEFICIAL EFFECTS OF THE INVENTION

This invention is designed to be only used by the authorized persons, and that is by setting the fingerprint in the finger detector (3), so that the specified user can use the device and transfer or save data. Other aspects and features of the invention will be illustrated in the following description and the attached protection components.

### DESCRIPTION OF FIGURES AND DRAWINGS

FIG. 1 General figure of the ring while it is used.

FIG. 2 Shows the internal components of the device.

The method of application of the invention industrially the Main piece:

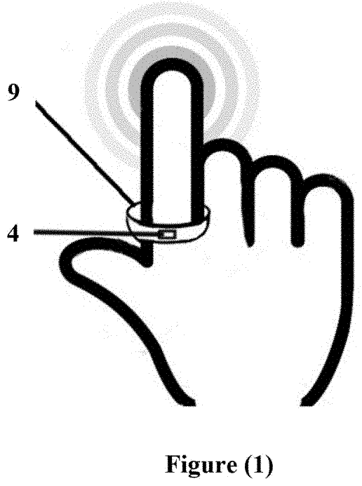

FIG. 1 shows how to use the ring using the finger by identifying the area or place to be scanned.

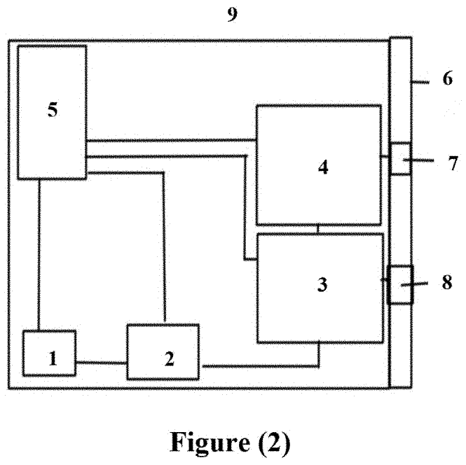

FIG. 2 also shows the current invention which consists of a portable easy-to-use ring that can be worn on the finger and used to wirelessly to scan, store and transfer data to any other display or storage unit. This ring (6) consists of an electric circuit which contains a programmer (2), storage memory (1), fingerprint detector (3) and one lens for scanning (4). This invention is designed to be only used by the authorized persons, and that is by setting and programming the fingerprint, so that the user can use the device to transfer or save data.

To use this invention, the actual user must set his fingerprint before using it by clicking on the fingerprint detector (3) for 10-15 seconds or less. The fingerprint is programmed by the programing unit (2) that is located inside the ring. This feature identifies the user's identity and authorizes him to use the ring. After checking the user's identity, make the ring in a front of the parts to be scanned including documents, books, etc. The scanning is done through the one lens (4) that are installed on the front (5) of the ring (6), then they are sent to memory storage (1) where images and other files are stored after they are converted into the required formats or extensions for the purpose of saving. The user can transfer the stored items to any other device that is compatible and paired with the ring to be scanned, displayed or printed directly by sending them wirelessly.

Another feature of the current invention is that the user can select only the desired area to be scanned, as the finger passing on the paper or materials to be scanned, then make a ring in the front of these materials as the programmer (2) will detect the fingerprint on it, which stored before inside the programmer (2). This will let the lens scan and take a photo for the required parts to be scanned either in a specific order or not, then they are scanned by the programmer (2). The programming unit (2) automatically identifies the specified area and scans it only, then it sends them to the storage memory (1).

The profiler comprises means to:

detect finger prints

store finger prints

compare finger prints

establish contour delimited by finger prints

detect surface delimited by contour

detect imperfections on the surface (concave/convex bulges)

take picture of surface

store picture

compare stored pictures

detect overlapping areas non-overlapping areas of pictures and analyze an overlapping picture then provide a real picture of it.

The electric circuit takes its electric power by means of a small (Fixed or rechargeable) battery inside the ring.

1-5. (canceled)

6. A ring scanning device comprising:
a ring unit;
a biometric fingerprint detector (3);
a memory storage (1) to store photos and files in different digital formats, wherein the storage memory can be extendable as desired;
a processor (2) with a non-transitory, computer-readable medium storing computer-readable instructions executable by a computer-implemented system in a destination network to perform:
scanning the desired areas, materials, or data;
authenticating the biometric fingerprint;
checking the user data;
verifying the user's identity; and
authorizing the user to use the device.

7. The ring according to claim 1, further comprising means allowing the user to scan a whole part of documents or materials desired to be scanned, wherein the said means control the size or diameter of the lenses and their scopes.

8. The ring according to claim 1, further comprising means allowing the user to scan a specific parts which can be selected by the fingerprint, wherein the borders of the part is automatically specified by the processor to scan only the specified part and exclude the other unspecified parts.

9. The ring according to claim 1, further comprising means for detecting and verifying finger prints.

10. The ring according to claim 1, further comprising means for storing fingerprints.

11. The ring according to claim 1, further comprising means for comparing and authenticating finger prints

12. The ring according to claim 1, further comprising means for establishing contour and slopes delimited by fingerprints

13. The ring according to claim 1, further comprising means for detecting surface delimited by contour

14. The ring according to claim 1, further comprising means for detecting imperfections on the surface (concave/convex bulges)

15. The ring according to claim 1, further comprising means for detecting overlapping and non-overlapping areas of pictures and analyze an overlapping picture then provide a real picture of it.

16. The ring according to claim 1, further comprising a rechargeable battery.
